(19) United States
(12) Patent Application Publication
(10) Pub. No.: US 2026/0186126 A1
(43) Pub. Date: Jul. 2, 2026

(54) DRONE-MOUNTED GROUND PENETRATING RADAR ANTENNA ALTITUDE AND TILT ADJUSTMENT SYSTEM

(71) Applicant: UNIVERSITY OF SHARJAH, Sharjah (AE)

(72) Inventors: Mohamed Ait GACEM, Sharjah (AE); Saleh ABU DABOUS, Sharjah (AE)

(21) Appl. No.: 19/432,278

(22) Filed: Dec. 24, 2025

Related U.S. Application Data
(60) Provisional application No. 63/740,566, filed on Dec. 31, 2024.

(51) Int. Cl. G01S 13/88; G01V 3/12

(52) U.S. Cl. CPC G01S 13/885; G01V 3/12

(57) ABSTRACT

An integrated peripheral drone-mounted ground penetrating radar (GPR) antenna altitude and tilt adjustment system is provided. The system includes a pulleys and ropes lifting mechanism connected to servo motors. The system includes a detachment mechanism controlled by a servo motor. The system includes a data processing and control circuit. The system includes a GPS module. The system includes a wireless transmitter and receiver circuit. The system includes infrared sensors. The system includes depth cameras. The system includes a battery. The system includes a voltage regulator.

### FIELD OF INVENTION

The present disclosure relates to drone-mounted ground penetrating radar systems, and more particularly to an integrated peripheral system for real-time altitude and tilt adjustment of a ground penetrating radar antenna using servo motor-controlled pulleys and ropes with automated and remotely controlled operational modes.

### BACKGROUND

Ground Penetrating Radar (GPR) non-destructive inspection is utilized in various civil engineering applications including underground utilities and pipelines evaluation, oil and gas industries, and pavement inspection. GPR scanners are mounted on inspection mediums such as GPR carts, drones, and inspection vehicles. Among these, drone-based GPR systems enable the inspection of areas that are inaccessible by traditional GPR inspection mediums.

The depth and accuracy of a GPR system is dependent on the antenna's characteristics and its distance from the inspected surface. Imaging performance is generally improved when the antenna-inspected surface separating distance is minimized, which helps maximize the energy transmitted and extracted through the surface to inner layers. However, in practice, the GPR antenna is lifted from the ground to avoid damage caused by friction and obstacles, which can result in deteriorated imaging quality due to lower signal strength of electromagnetic waves passing through the ground. Higher separation distances between the GPR antenna and inspected surfaces can result in higher signal to noise ratio and lower spatial resolution, which makes radargram interpretation more challenging.

A common approach to address antenna height limitations involves covering the antenna with a protective cover, then replacing it when worn out. However, the replacement of such casing can be time-consuming and costly. Additionally, different casing materials and thicknesses affect the antenna's characteristics and alter the depth of inspection. Drone-based GPR inspection systems are particularly affected by antenna height limitations, since a higher safety distance is used to avoid contact with the inspected surface, which might result in destabilizing the drone.

Another limitation facing existing GPR inspection mediums, including drone-based systems, is that they are primarily designed to inspect flat surfaces, thus restricting spatial manipulation of the antenna. This can prevent inserting the GPR antenna in tight spaces or in-between-cracks. Such limitations can restrict the evaluation of structures like rocky formations with cavities, damaged structures during disaster response scenarios, and complex archeological sites.

Accordingly, there is a general desire for improved systems and methods for drone-mounted GPR antenna positioning that address at least some of these considerations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an integrated peripheral drone-mounted ground penetrating radar (GPR) antenna altitude and tilt adjustment system is provided. The system includes a pulleys and ropes lifting mechanism connected to servo motors. The system includes a detachment mechanism controlled by a servo motor. The system includes a data processing and control circuit. The system includes a GPS module. The system includes a wireless transmitter and receiver circuit. The system includes infrared sensors. The system includes depth cameras. The system includes a battery. The system includes a voltage regulator.

According to other aspects of the present disclosure, the proposed system includes one or more of the following features. The system operates in automated and remotely controlled modes. In the automated mode, the system automatically adjusts the antenna's altitude and tilt degree according to height variations of the inspected surface and obstacles present in the antenna's path. In the remotely controlled mode, the system transmits height variation data and a real-time video stream through the wireless transmitter and receiver circuit to an operator, who accordingly performs remotely controlled antenna height and tilt degree adjustments. The system includes a detachment mechanism that is activated by the operator in case the system gets stuck while performing inspection or causes destabilization to the drone. The servo motor-based detachment mechanism liberates the drone from the peripheral system, which constantly broadcasts its location through the built-in GPS module, thus facilitating its localization by search teams. The system further performs topographical depth estimation of the surface inspected by the GPR antenna simultaneously along with obstacle detection by utilizing the infrared sensors and depth cameras, which contributes to sensor-fusion based GPR inspection applications by providing a corresponding surface depth map of inner layers inspected by the GPR.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts a perspective view of a drone-mounted GPR antenna altitude and tilt adjustment peripheral system attached to a drone, according to aspects of the present disclosure.

FIG. 2 depicts a three-dimensional view of the peripheral system of FIG. 1 in an assembled configuration, according to an embodiment.

FIG. 3 depicts a three-dimensional view of the peripheral system of FIG. 1 showing a GPR antenna suspended below a housing, according to aspects of the present disclosure.

FIG. 4 depicts a top view of an upper platform of the peripheral system of FIG. 1, according to an embodiment.

FIG. 5 depicts a detailed view of a lower platform assembly of the peripheral system of FIG. 1, according to aspects of the present disclosure.

FIG. 6 depicts a view of a servo motor and pulley mechanism of the peripheral system of FIG. 1, according to an embodiment.

FIG. 7 depicts a side perspective view of the lower platform assembly of the peripheral system of FIG. 1, according to aspects of the present disclosure.

FIG. 8 depicts a three-dimensional view of the lower platform assembly of the peripheral system of FIG. 1 showing a pulley and rope mechanism, according to an embodiment.

FIG. 9 depicts a sequence of views illustrating tilt adjustment capability of the peripheral system of FIG. 1, according to aspects of the present disclosure.

FIG. 10 depicts a bottom perspective view of the peripheral system of FIG. 1 attached to a quadcopter drone, according to an embodiment.

FIG. 11 depicts an illustration of the peripheral system of FIG. 1 in operation over a rocky terrain environment, according to aspects of the present disclosure.

FIG. 12 depicts a sequential illustration of a GPR antenna navigating through a rocky formation, according to an embodiment.

FIG. 13 depicts an illustration of the peripheral system of FIG. 1 in operation over a rocky outcrop, according to aspects of the present disclosure.

FIG. 14 depicts a flowchart illustrating workflow and operational modes of the peripheral system of FIG. 1, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

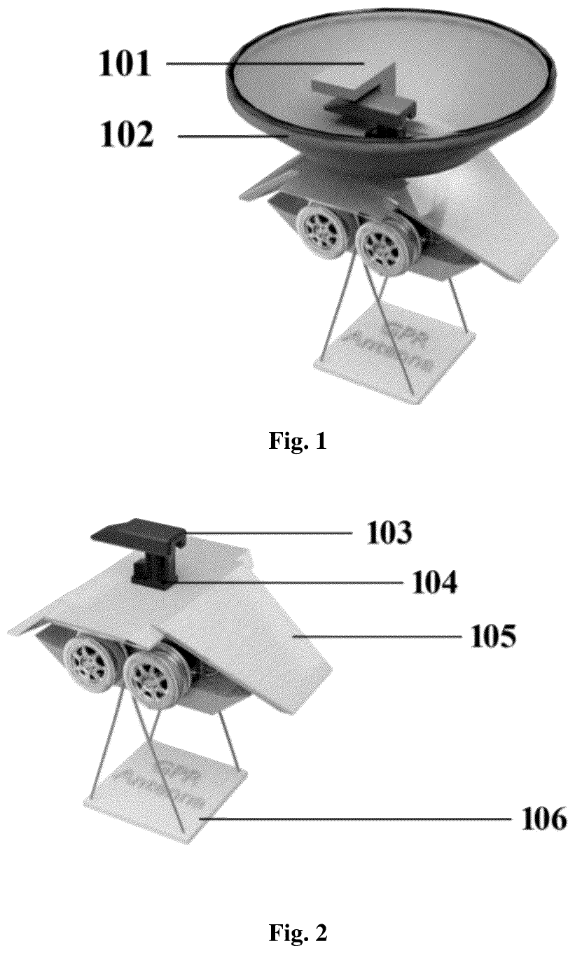

The present disclosure relates to an integrated peripheral drone-mounted Ground Penetrating Radar (GPR) antenna altitude and tilt adjustment system. The system is designed to function as a peripheral system that attaches to existing drones. In some cases, the peripheral configuration facilitates adoption in practical setups by allowing the system to be mounted on various drone platforms without requiring modification to the drone itself. FIG. 1 is a perspective view of a drone-mounted GPR antenna altitude and tilt adjustment peripheral system attached to a drone, including a drone attachment platform 101, a drone attachment platform 102, and a GPR antenna 106.

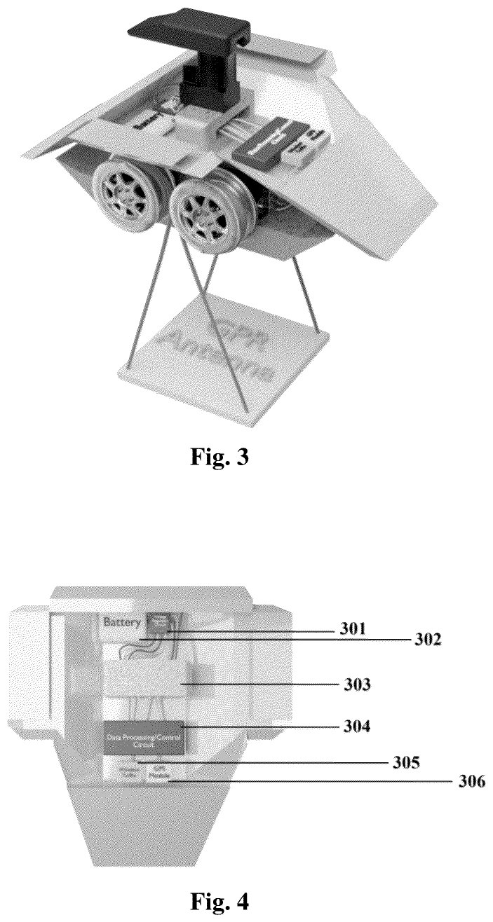

FIG. 2 is a perspective view of the drone-mounted GPR antenna altitude and tilt adjustment peripheral system in an assembled configuration, including a servo motor head 103, a detachment servo motor 104, an upper platform 105, and a GPR antenna 106. FIG. 3 is a perspective view of the drone-mounted GPR antenna altitude and tilt adjustment peripheral system showing the lower platform structure with servo motors and the pulley and rope mechanism, including an upper platform 105 and a GPR antenna 106.

The proposed system comprises a four-platform architecture. The four-platform architecture include a drone attachment platform, an upper platform, a middle platform, and a lower platform. The drone attachment platform provides a mounting interface between the system and a host drone. The upper platform houses various electronic components and sensing elements. The middle platform connects the upper platform to the lower platform and provides structural support for the system. The lower platform supports components associated with altitude and tilt adjustment mechanisms.

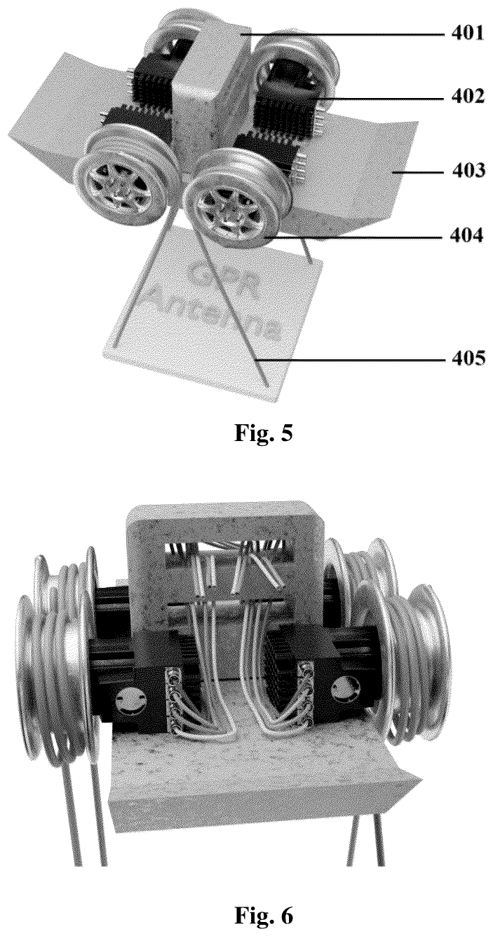

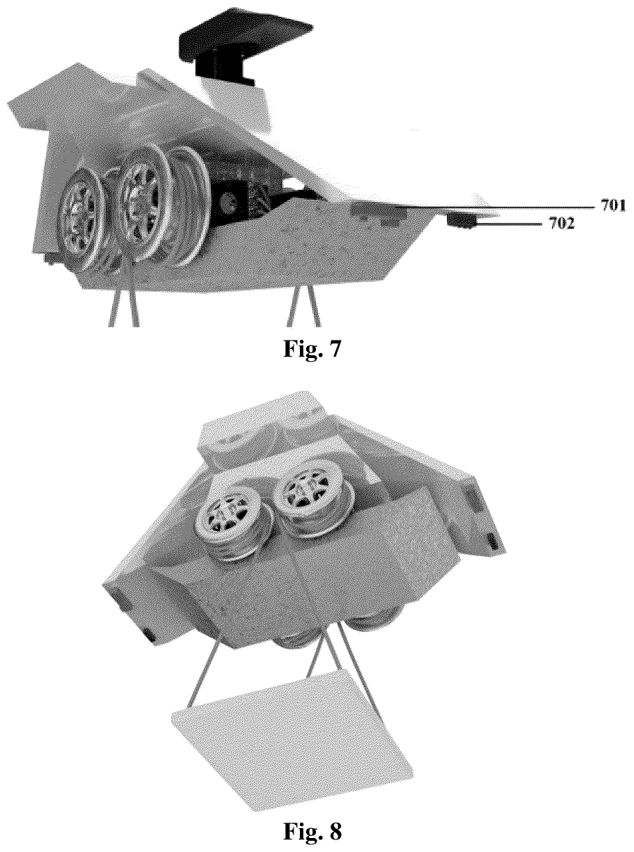

FIG. 4 is a top view of the upper platform of the drone-mounted GPR antenna altitude and tilt adjustment peripheral system, including a voltage regulator circuit 301, a battery 302, a middle platform 303, a data processing and control circuit 304, a wireless transmitter and receiver circuit 305, and a GPS module 306. FIG. 5 is a detailed view of the lower platform assembly of the drone-mounted GPR antenna altitude and tilt adjustment peripheral system, including a middle platform 401, a plurality of servo motors 402, a lower platform 403, a plurality of pulleys 404, and a plurality of ropes 405. FIG. 6 is a view of the lower platform assembly showing the servo motor and pulley mechanism with wiring connections extending from the servo motors to the data processing and control circuitry. FIG. 7 is a side perspective view of the lower platform assembly of the drone-mounted GPR antenna altitude and tilt adjustment peripheral system, including an infrared sensor 701 and a depth camera 702. FIG. 8 is a three-dimensional view of the lower platform assembly showing the pulley and rope mechanism with four servo motors equipped with pulleys and ropes extending downward to a GPR antenna mounting surface.

In some cases, the four-platform architecture provides a modular configuration that distributes system components across multiple levels. The drone attachment platform is fixed to a designated inspection drone. The upper platform, middle platform, and lower platform are arranged in a vertically stacked configuration below the drone attachment platform. The middle platform serves as an intermediate structural element that connects the upper platform to the lower platform. The upper platform houses a plurality of electronic components and sensing elements. In some cases, the upper platform contains a battery that provides electrical power to the system. A voltage regulator circuit is positioned on the upper platform and is connected to the battery. The voltage regulator circuit conditions the electrical power supplied by the battery for distribution to other system components. A data processing/control circuit is further disposed on the upper platform. The data processing/control circuit receives sensor data and generates control signals for various system actuators. A GPS module is located on the upper platform. The GPS module provides location data for the system. A wireless transmitter/receiver (Tx/Rx) circuit is housed on the upper platform. The wireless Tx/Rx circuit enables communication between the system and a remote operator or control station.

In an embodiment, the upper platform contains sensing elements for surface detection and obstacle identification. Two infrared (IR) sensors are positioned on the upper platform. The two IR sensors are oriented to face a downward direction toward an inspected surface. Two depth cameras are also disposed on the upper platform. The two depth cameras are configured to capture depth images of terrain below the system. The IR sensors and depth cameras provide data to the data processing/control circuit for altitude estimation and obstacle detection. The lower platform supports components associated with altitude and tilt adjustment mechanisms. In some cases, four servo motors are disposed on the lower platform. The four servo motors are connected to a system of pulleys and ropes. The pulleys and ropes extend from the lower platform to a GPR antenna suspended below the system. Rotation of each servo motor causes corresponding movement of the ropes through the pulleys, thereby adjusting altitude and tilt of the GPR antenna.

All components of the system are powered by the battery connected to the voltage regulator circuit on the upper platform. The voltage regulator circuit distributes regulated electrical power from the battery to the data processing/control circuit, the GPS module, the wireless Tx/Rx circuit, the IR sensors, the depth cameras, and the servo motors on the lower platform. The middle platform connects the upper platform to the lower platform. In some cases, the middle platform provides structural support between the upper platform and the lower platform. A servo motor associated with a detachment mechanism is housed on the middle platform. The servo motor on the middle platform is positioned at a junction between the drone attachment platform and the integrated system body. The servo motor on the middle platform is configured to actuate the detachment mechanism when activated.

The GPR antenna is suspended below the system by a plurality of cables. The plurality of cables extends from the lower platform to attachment points on the GPR antenna. In some cases, the plurality of cables is routed through a corresponding plurality of pulleys disposed on the lower platform. Each pulley is mechanically coupled to a respective servo motor. The servo motors are configured to rotate in response to control signals received from the data processing/control circuit. Rotation of each servo motor results in pulling or pushing of the cables connected to the respective pulley. When a servo motor rotates in a first direction, the servo motor causes the corresponding cable to be pulled, thereby raising a portion of the GPR antenna connected to that cable. When the servo motor rotates in a second direction opposite the first direction, the servo motor causes the corresponding cable to be released or pushed, thereby lowering the portion of the GPR antenna connected to that cable. The pulling and pushing of the cables adjust both altitude and tilt degree of the GPR antenna platform relative to the lower platform.

In an embodiment, the servo motors provide constant position feedback to the data processing/control circuit. The position feedback includes information regarding rotational position of each servo motor. The data processing/control circuit receives the position feedback from each servo motor and uses the position feedback to determine a current altitude and tilt degree of the GPR antenna. The constant position feedback enables accurate altitude and tilt degree control by allowing the data processing/control circuit to compare actual servo motor positions with commanded positions and to adjust as needed. The data processing/control circuit generates control signals for the servo motors based on sensor data received from the IR sensors and depth cameras. The control signals specify rotation speed and rotation degree for each servo motor. The servo motors execute the control signals while simultaneously transmitting position feedback to the data processing/control circuit. The closed-loop configuration between the data processing/control circuit and the servo motors provides precise control over GPR antenna positioning.

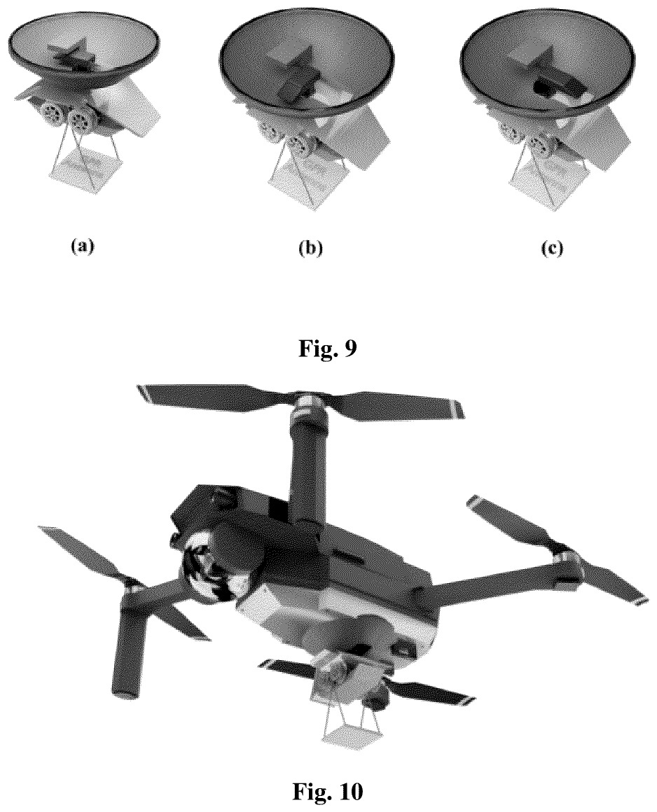

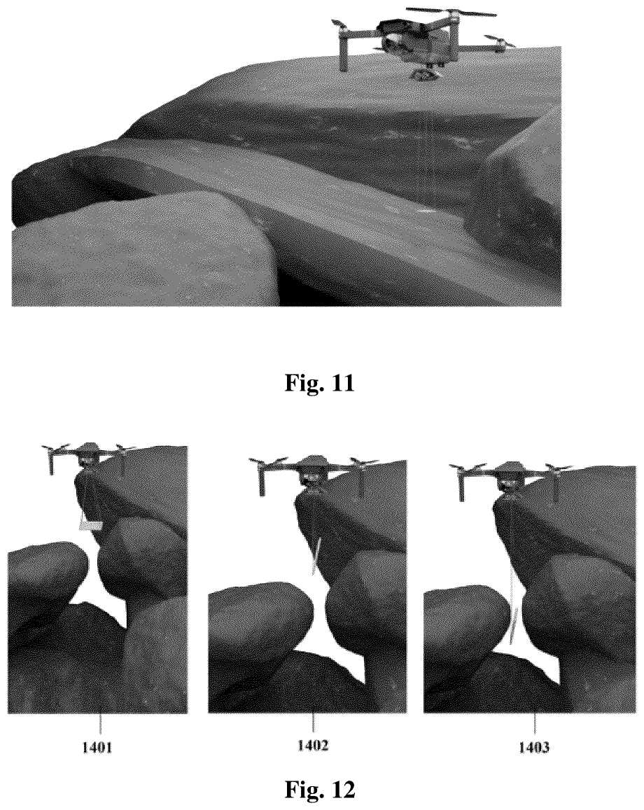

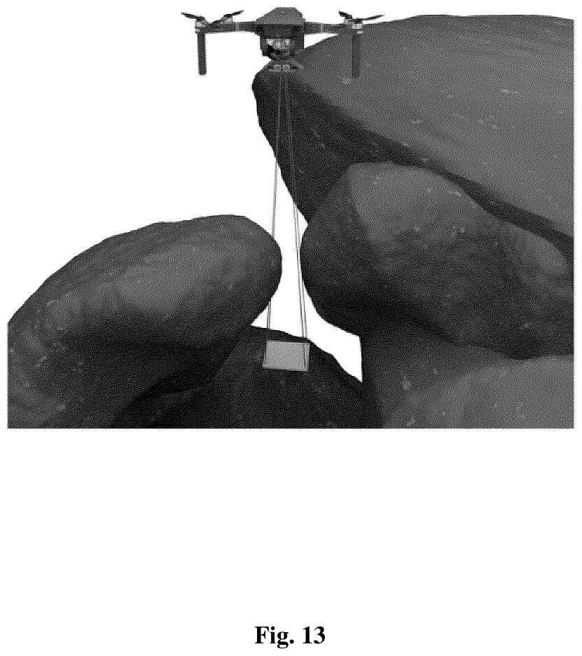

FIG. 9 is a sequential illustration showing the tilt adjustment capability of the drone-mounted GPR antenna altitude and tilt adjustment peripheral system, depicting views (a), (b), and (c) with the GPR antenna in different tilted orientations. FIG. 10 is a bottom perspective view of the drone-mounted GPR antenna altitude and tilt adjustment peripheral system attached to a quadcopter drone, showing the peripheral system with sensor components including infrared sensors and depth cameras oriented to face a downward direction. FIG. 11 is an illustration of the drone-mounted GPR antenna altitude and tilt adjustment peripheral system in operation over a rocky terrain environment, showing infrared beams projecting downward onto a rock surface to illustrate height sensing and obstacle detection functionality. FIG. 12 is a sequential illustration labeled 1401, 1402, and 1403 depicting a drone-mounted GPR system navigating through a rocky formation with tight spaces, showing the GPR antenna transitioning from a horizontal orientation to a vertical orientation to pass through a narrow gap between rocks. FIG. 13 is an illustration of the drone-mounted GPR antenna altitude and tilt adjustment peripheral system in operation over a rocky terrain environment, showing the GPR antenna suspended via the rope and pulley mechanism and positioned in proximity to an irregular rocky surface.

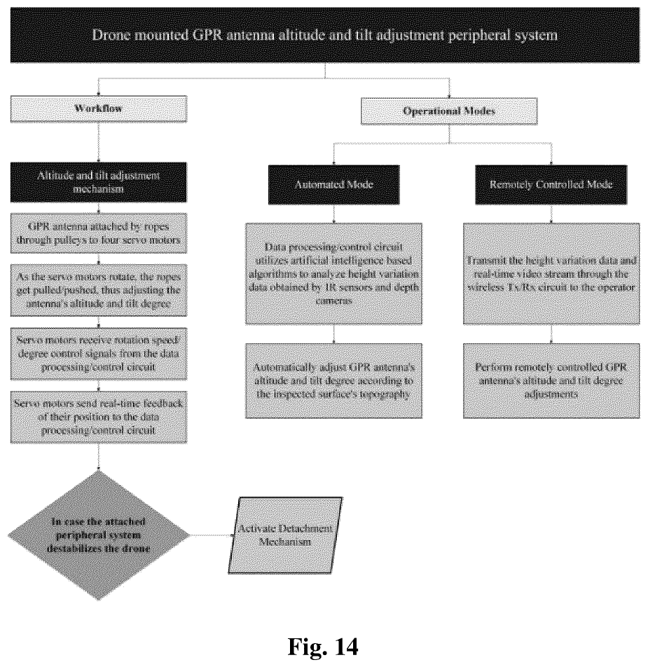

FIG. 14 is a flowchart illustrating the workflow and operational modes of the drone-mounted GPR antenna altitude and tilt adjustment peripheral system, including a workflow branch describing the altitude and tilt adjustment mechanism and an operational modes branch depicting automated mode and remotely controlled mode.

In some cases, all servo motors rotate simultaneously to enable the GPR antenna to pass through tight spaces. After an orientation adjustment has been performed to reposition the GPR antenna, the data processing/control circuit commands all servo motors to rotate in a coordinated manner. The simultaneous rotation of all servo motors causes the GPR antenna to move vertically while maintaining the adjusted orientation. The coordinated movement allows the GPR antenna to traverse through narrow openings or confined areas that would otherwise be inaccessible. In an embodiment, the infrared sensors and depth cameras are positioned on sideways portions of the upper platform. The infrared sensors and depth cameras are oriented to face a downward direction toward terrain below the system. The sideways placement of the infrared sensors and depth cameras on the upper platform provides a field of view that encompasses areas beneath and around the GPR antenna during operation.

The infrared sensors provide short-range height measurement capability. The infrared sensors emit infrared radiation toward the inspected surface and detect reflected infrared radiation returning from the inspected surface. Based on characteristics of the reflected infrared radiation, the infrared sensors generate height measurement data corresponding to distances between the system and the inspected surface. The short-range height measurement provided by the infrared sensors are suitable for detecting surface height variations in close proximity to the GPR antenna. The depth cameras provide long-range obstacle detection capability. The depth cameras capture depth images that represent three-dimensional information about terrain and objects below the system. The depth images include distance information for multiple points within a field of view of each depth camera. The long-range obstacle detection provided by the depth cameras enable identification of obstacles at distances greater than the effective range of the infrared sensors.

In an embodiment, the dual-range sensing capability provided by the combination of infrared sensors and depth cameras enables detection across both short-range and long-range distances. The infrared sensors detect surface height variations and obstacles within a first distance range corresponding to short-range detection. The depth cameras detect obstacles and terrain features within a second distance range corresponding to long-range detection. The second distance range extend beyond the first distance range, thereby providing advance warning of approaching obstacles or terrain changes.

The data processing/control circuit receive data from both the infrared sensors and the depth cameras. The data processing/control circuit jointly analyze the data obtained from the infrared sensors and the depth cameras. The joint analysis combines short-range height measurement data from the infrared sensors with long-range obstacle detection data from the depth cameras. Based on the joint analysis, the data processing/control circuit determine a suitable altitude adjustment for the GPR antenna. In an embodiment, the joint analysis of data from the infrared sensors and depth cameras enables the system to estimate surface height variations. The surface height variations correspond to changes in elevation of the inspected surface along a path of the GPR antenna. The data processing/control circuit process the combined sensor data to generate a representation of surface topography beneath the system. The representation of surface topography informs altitude adjustment decisions to maintain the GPR antenna at a desired proximity to the inspected surface.

The joint analysis also enables the system to detect the presence of obstacles in a path of the GPR antenna. Obstacles include rocks, debris, vegetation, structural elements, or other objects that protrude above the inspected surface. The data processing/control circuit identifies obstacles based on depth discontinuities in the depth camera data or based on anomalous readings from the infrared sensors. Upon detecting an obstacle, the data processing/control circuit generates control signals to adjust the altitude of the GPR antenna to avoid collision with the detected obstacle. In some cases, the system operates in an automated mode. In the automated mode, the data processing/control circuit utilizes artificial intelligence-based analysis to adjust the GPR antenna altitude and tilt degree in real-time. The artificial intelligence-based analysis processes sensor data from the infrared sensors and depth cameras to determine appropriate adjustments for the GPR antenna positioning. The data processing/control circuit generates control signals for the servo motors based on the artificial intelligence-based analysis.

The automated mode is configured to ensure that the GPR antenna remains at a proximity to the inspected surface that is as close as possible without causing friction or collision-related damage to the antenna. The artificial intelligence-based analysis evaluates surface height variations and obstacle positions to calculate an altitude that maintains the GPR antenna near the inspected surface while avoiding contact. The data processing/control circuit continuously updates the altitude and tilt degree of the GPR antenna as the system traverses over varying terrain. In some cases, the artificial intelligence-based analysis includes evaluation of multiple factors to determine appropriate antenna positioning. The factors include current surface height beneath the GPR antenna, detected obstacles in the path of the GPR antenna, rate of change of surface height, and predicted terrain features based on depth camera data. The data processing/control circuit weighs the multiple factors to generate control signals that balance proximity to the inspected surface against risk of collision or friction damage.

The system utilizes artificial intelligence-based processing algorithms to facilitate navigation through confined spaces. The artificial intelligence-based processing algorithms include computer vision-based distance estimation techniques. The computer vision-based distance estimation techniques process depth images captured by the depth cameras to determine spatial dimensions of openings, gaps, or passages in the terrain or surrounding structures. In some cases, the computer vision-based distance estimation techniques are applied to determine whether an antenna orientation is sufficient for passing through a designated tight area. The data processing/control circuit analyzes depth images to identify boundaries of a tight area, such as a crack, crevice, or narrow opening. The data processing/control circuit calculates dimensions of the tight area based on the computer vision-based distance estimation. The calculated dimensions are compared against dimensions of the GPR antenna in a current or proposed orientation.

The artificial intelligence-based processing algorithms evaluate whether the GPR antenna can pass through the designated tight area in a current orientation. If the current orientation is insufficient for passage, the data processing/control circuit calculates an alternative orientation that would allow the GPR antenna to fit through the tight area. The alternative orientation involves tilting the GPR antenna from a horizontal orientation toward a vertical orientation by actuating selected servo motors to pull cables on one side of the antenna while maintaining cables on an opposite side in a stationary position. After an orientation adjustment has been performed, the artificial intelligence-based processing algorithms re-evaluate whether the new antenna orientation is sufficient for passing through the designated tight area. The computer vision-based distance estimation techniques compare the dimensions of the GPR antenna in the new orientation against the dimensions of the tight area. If the new orientation is determined to be sufficient, the data processing/control circuit commands the servo motors to move the GPR antenna through the tight area. If the new orientation is determined to be insufficient, the data processing/control circuit calculates further orientation adjustments or determines that the tight area is impassable.

In another embodiment, the proposed system operates in a remotely controlled mode. In the remotely controlled mode, the data processing/control circuit transmits height variation data and a live video stream through the wireless Tx/Rx circuit to an operator. The height variation data includes information derived from the infrared sensors and depth cameras regarding surface elevation changes and distances between the GPR antenna and the inspected surface. The live video stream includes real-time imagery captured by the depth cameras showing terrain and obstacles beneath the system. The operator receives the height variation data and live video stream at a remote-control station. The remote-control station includes a display device configured to present the live video stream to the operator. The remote-control station also includes interface elements that display the height variation data in a format readable by the operator. Based on the received height variation data and live video stream, the operator assesses current conditions beneath the GPR antenna and determines appropriate adjustments to antenna positioning.

In the remotely controlled mode, the operator performs remotely controlled adjustments to the GPR antenna altitude and tilt degree. The operator inputs adjustment commands through a control interface at the remote-control station. The adjustment commands specify desired changes to altitude, tilt degree, or both altitude and tilt degree of the GPR antenna. The control interface transmits the adjustment commands wirelessly to the system. The wireless Tx/Rx circuit receives the adjustment commands transmitted from the remote-control station. The wireless Tx/Rx circuit relays the received adjustment commands to the data processing/control circuit. The data processing/control circuit interprets the adjustment commands and generates corresponding control signals for the servo motors. The servo motors execute the control signals to adjust the altitude and tilt degree of the GPR antenna according to the operator's commands.

In some cases, the remotely controlled mode enables the operator to make real-time adjustments based on visual observation of the live video stream. The operator observes obstacles, terrain features, or surface conditions in the live video stream that warrant adjustment of the GPR antenna positioning. The operator inputs adjustment commands in response to the observed conditions. The system executes the adjustment commands to reposition the GPR antenna as directed by the operator. The remotely controlled mode provides the operator with situational awareness through the combination of height variation data and live video stream. The height variation data provides quantitative information regarding distances and elevation changes. The live video stream provides qualitative visual information regarding the environment beneath the system. The operator uses both types of information to make informed decisions regarding GPR antenna positioning during inspection operations.

In another embodiment, the proposed system enables passing the GPR antenna through tight spaces and cracks. The tight spaces and cracks include narrow openings, crevices, gaps between structural elements, or confined passages that have dimensions smaller than a width of the GPR antenna in a horizontal orientation. To navigate through such tight spaces and cracks, the system adjusts the orientation of the GPR antenna from a horizontal position to a vertical position or to an intermediate tilted position. The orientation adjustment is achieved by rotating only one side of the servo motor-controlled pulleys. When the system detects a tight space or crack that requires orientation adjustment, the data processing/control circuit generates control signals that command servo motors on one side of the lower platform to rotate while servo motors on an opposite side of the lower platform remain stationary. The selective actuation of servo motors on only one side causes the cables connected to the rotating servo motors to be pulled, while the cables connected to the stationary servo motors maintain their current length.

The pulling of cables on one side of the GPR antenna while keeping cables on the opposite side stationary results in shifting the antenna orientation from horizontal to vertical. As the cables on one side are pulled upward through the pulleys, the corresponding side of the GPR antenna rises relative to the opposite side. The opposite side of the GPR antenna, connected to the stationary cables, remains at its current altitude. The differential movement between the two sides of the GPR antenna causes the antenna to rotate about an axis, transitioning from a horizontal orientation toward a vertical orientation. The degree of orientation shift is controlled by the amount of rotation applied to the servo motors on the active side. A partial rotation of the servo motors produces a tilted orientation that is intermediate between horizontal and vertical. A full rotation of the servo motors produces a substantially vertical orientation of the GPR antenna. The data processing/control circuit calculates the required servo motor rotation based on the dimensions of the tight space or crack and the dimensions of the GPR antenna.

In an embodiment, the GPR antenna performs imaging in a tilt position. After the orientation of the GPR antenna has been adjusted to a tilted or vertical position to pass through a tight space or crack, the GPR antenna conducts radar imaging while maintaining the adjusted orientation. The tilted or vertical orientation allows the GPR antenna to capture radar data from surfaces or subsurface features that are accessible through the tight space or crack. The imaging in a tilt position enables inspection of areas that would be inaccessible with the GPR antenna in a horizontal orientation. In another embodiment, the GPR antenna returns to its original orientation after passing through a tight space or crack. The data processing/control circuit evaluates the observed geometry of the terrain or structure beyond the tight space or crack. If the observed geometry permits the GPR antenna to operate in a horizontal orientation, the data processing/control circuit generates control signals to return the GPR antenna to the original horizontal orientation. The return to the original orientation is achieved by rotating the servo motors on the previously active side in a reverse direction to release the pulled cables, while the servo motors on the opposite side remain stationary or rotate to maintain antenna stability.

The decision to maintain a tilted orientation or to return to the original horizontal orientation depends on the observed geometry of the inspection area. If the observed geometry includes additional tight spaces, irregular surfaces, or obstacles that favor a tilted orientation, the GPR antenna continues imaging in the tilted position. If the observed geometry includes open areas or flat surfaces that favor a horizontal orientation, the GPR antenna returns to the original horizontal orientation for continued imaging. The data processing/control circuit continuously evaluates the observed geometry and adjusts the antenna orientation as conditions change during the inspection operation.

In some cases, the system includes a detachment mechanism that enables separation of the peripheral system from the drone. The detachment mechanism is activated remotely by an operator. The remote activation occurs when the peripheral system becomes stuck during an inspection operation. The remote activation also occurs when the peripheral system causes instability to the drone while in operation. The detachment mechanism allows the drone to be liberated from the peripheral system, thereby preserving the drone when the peripheral system encounters conditions that prevent continued safe operation. Under normal operating conditions, a servo motor head associated with the detachment mechanism resides securely within the drone attachment platform. The servo motor head is positioned within a cavity or recess of the drone attachment platform such that the servo motor head engages with corresponding structure of the drone attachment platform. The engagement between the servo motor head and the drone attachment platform maintains a secure mechanical connection between the peripheral system and the drone during normal flight and inspection operations.

When the detachment mechanism is activated, the servo motor associated with the detachment mechanism rotates. The servo motor rotates approximately 180 degrees from an initial position. As the servo motor rotates, the servo motor head moves through an arc within the drone attachment platform. The rotation of the servo motor causes the servo motor head to travel from an engaged position toward an empty region of the drone attachment platform. Upon completing the 180-degree rotation, the servo motor head reaches the empty region of the drone attachment platform. The empty region corresponds to a portion of the drone attachment platform that lacks structure for engaging with the servo motor head. When the servo motor head reaches the empty region, the servo motor head loses contact with the drone attachment platform. Without the mechanical engagement between the servo motor head and the drone attachment platform, the peripheral system is no longer secured to the drone. After the servo motor head loses contact with the drone attachment platform, the peripheral system falls away from the drone due to gravity. The weight of the peripheral system, including the upper platform, middle platform, lower platform, and suspended GPR antenna, causes the peripheral system to descend when the mechanical connection to the drone is released. The drone, freed from the peripheral system, then continues flight operations or return to a designated location.

In some cases, the detached peripheral system broadcasts location information to facilitate retrieval. A GPS module disposed on the upper platform of the peripheral system generate location data corresponding to a geographic position of the detached peripheral system. The GPS module transmits the location data through a wireless communication circuit. The location data is broadcast continuously or at periodic intervals following detachment. Search teams receive the broadcast location data from the GPS module of the detached peripheral system. The broadcast location data enable search teams to locate the detached peripheral system for retrieval. The GPS-based location broadcasting facilitates recovery of the peripheral system and associated components, including the GPR antenna, after a detachment event has occurred.

In another embodiment, the proposed system records a topographical surface depth map of an inspected surface using the infrared sensors and depth cameras simultaneously with GPR inspection operations. During an inspection operation, the GPR antenna transmits radar signals into the inspected surface and receive reflected signals that provide information regarding subsurface features and layers. Concurrently, the infrared sensors and depth cameras capture surface elevation data corresponding to the terrain above which the GPR antenna is operating. The data processing/control circuit processes the surface elevation data from the infrared sensors and depth cameras to generate the topographical surface depth map.

The topographical surface depth map represents variations in surface elevation across an inspection area. The infrared sensors provide height measurements at locations beneath the system as the system traverses the inspection area. The depth cameras capture depth images that include distance information for multiple points within a field of view. The data processing/control circuit aggregates the height measurements from the infrared sensors and the distance information from the depth images to construct the topographical surface depth map. The topographical surface depth map is recorded in a data storage medium for subsequent analysis or is transmitted through the wireless Tx/Rx circuit to a remote station. The simultaneous recording of the topographical surface depth map and GPR inspection data enables correlation between surface features and subsurface features. The GPR antenna generates radargram data that represents underground layers and structures beneath the inspected surface. The topographical surface depth map provides a reference frame for interpreting the radargram data by indicating the elevation of the surface at each location where GPR data was collected. The correlation between surface elevation and subsurface imaging enhances interpretation of GPR inspection results.

In some cases, fusion of surface depth data obtained by the system with underground layers imaging performed by the GPR antenna enables sensor-fusion based GPR inspection applications. The surface depth data includes the topographical surface depth map generated from the infrared sensors and depth cameras. The underground layers imaging includes radargram data or processed subsurface imagery generated by the GPR antenna. The data processing/control circuit or an external processing system combines the surface depth data with the underground layers imaging to produce fused inspection data.

The sensor-fusion based GPR inspection applications provide corresponding surface depth maps of inner layers inspected by the GPR. The fused inspection data associates each subsurface feature or layer identified in the GPR imaging with a corresponding surface elevation from the topographical surface depth map. The association between surface elevation and subsurface features enables determination of absolute depths of subsurface layers relative to a reference datum. The fused inspection data also enables visualization of subsurface features in relation to surface topography. The fusion of surface depth data with underground layers imaging enhances accuracy of depth calculations for subsurface features. When the GPR antenna operates over terrain with varying surface elevation, the radargram data reflects variations in antenna height above the inspected surface. The topographical surface depth map provides correction factors that account for surface elevation variations when calculating depths of subsurface features. The corrected depth calculations improve accuracy of subsurface feature localization in sensor-fusion based GPR inspection applications.

In some cases, the sensor-fusion based GPR inspection applications enable generation of three-dimensional representations of inspected structures. The topographical surface depth map provides surface geometry information in three dimensions. The underground layers imaging from the GPR antenna provide subsurface geometry information. The fusion of surface geometry information with subsurface geometry information enables construction of three-dimensional models that represent both surface topography and subsurface features of an inspected area. The three-dimensional representations facilitate evaluation of structures such as rocky formations, archaeological sites, or damaged buildings where both surface and subsurface information contribute to assessment of structural conditions. The proposed system enables inspection of areas that are inaccessible by traditional GPR carrying mediums. Traditional GPR carrying mediums include GPR carts and inspection vehicles. GPR carts are wheeled platforms that support a GPR antenna and are pushed or pulled along an inspected surface. Inspection vehicles are motorized platforms that carry GPR equipment along roads, pavements, or other traversable surfaces. Traditional GPR carrying mediums are limited to operating on surfaces that are relatively flat, continuous, and accessible by ground-based travel.

In another embodiment, traditional GPR carrying mediums cannot access areas due to terrain characteristics. Terrain characteristics that prevent access by traditional GPR carrying mediums include steep slopes, rocky outcrops, unstable ground, water bodies, dense vegetation, or elevated structures. Traditional GPR carrying mediums also are unable to access areas that lack continuous ground paths, such as isolated rock formations, cliff faces, or structures surrounded by hazardous conditions. The drone-mounted configuration of the system overcomes terrain-based access limitations by enabling aerial approach to inspection areas.

The system enables inspection of areas that are physically separated from accessible ground surfaces. Areas that are physically separated from accessible ground surfaces include elevated platforms, rooftops, bridge undersides, or structures located across gaps or voids. Traditional GPR carrying mediums are unable to reach such areas without construction of temporary access structures or deployment of specialized equipment. The aerial mobility provided by the drone platform allows the system to reach physically separated areas without requiring ground-based access infrastructure. In some cases, the system enables inspection of tight spaces. Tight spaces include narrow openings, confined passages, gaps between structural elements, or restricted areas that have dimensions smaller than the operational envelope of traditional GPR carrying mediums. Traditional GPR carrying mediums are unable to enter tight spaces due to the physical dimensions of the cart or vehicle platform. The system navigates into tight spaces by adjusting the orientation of the GPR antenna from a horizontal position to a tilted or vertical position, thereby reducing the effective width of the antenna assembly.

The system enables inspection of in-between-cracks. In-between-cracks include fissures, fractures, joints, or narrow separations in rock formations, concrete structures, or other materials. In-between-cracks have widths that are insufficient to accommodate traditional GPR carrying mediums. The system positions the GPR antenna within or adjacent to in-between-cracks by utilizing the altitude and tilt adjustment capabilities to orient the antenna for passage through narrow openings. The GPR antenna captures radar data from surfaces and subsurface features accessible through the in-between-cracks.

In some cases, the system enables evaluation of rocky formations with cavities. Rocky formations with cavities include natural geological structures that contain voids, caves, hollow spaces, or internal chambers. Rocky formations with cavities are located in mountainous terrain, coastal cliffs, desert landscapes, or other environments where traditional GPR carrying mediums cannot operate. The system approaches rocky formations with cavities from aerial positions and adjusts the GPR antenna altitude and tilt to inspect surfaces and subsurface features of the rocky formations. The GPR antenna detects cavities within the rocky formations by identifying radar signal reflections from void boundaries.

The proposed system enables evaluation of demolished buildings during disaster response. Demolished buildings include structures that have collapsed, partially collapsed, or sustained damage that renders the structures unsafe for ground-based access. During disaster response operations, traditional GPR carrying mediums are unable to traverse debris fields, unstable rubble, or hazardous areas surrounding demolished buildings. The system operates above demolished buildings without requiring ground contact, thereby enabling GPR inspection of debris piles and collapsed structures. The GPR antenna detects voids, buried objects, or survivors beneath rubble by capturing radar data from positions above the demolished buildings.

In an embodiment, the proposed system enables evaluation of complex archeological sites. Complex archeological sites include locations with irregular terrain, fragile surfaces, restricted access areas, or structures that cannot tolerate contact with ground-based equipment. Complex archeological sites contain artifacts, buried structures, or subsurface features that require non-invasive inspection methods. Traditional GPR carrying mediums are unsuitable for complex archeological sites due to potential damage to surface features or inability to access elevated or confined areas. The system inspects complex archeological sites by maintaining the GPR antenna at controlled altitudes above fragile surfaces and by adjusting antenna orientation to access confined spaces within the sites.

The altitude and tilt adjustment capabilities of the proposed system facilitate inspection of structures with complex geometric shapes. Structures with complex geometric shapes include surfaces that are curved, angled, stepped, or otherwise non-planar. Traditional GPR carrying mediums are designed for inspection of flat or uniformly sloped surfaces and are unable to maintain consistent antenna-to-surface distances over complex geometric shapes. The system then adjusts the GPR antenna altitude in real-time to maintain a desired proximity to surfaces with varying elevations. The system also adjusts the GPR antenna tilt to align the antenna with angled or curved surfaces, thereby improving radar signal coupling with the inspected surface.

In an embodiment, the proposed system enables inspection operations in environments where ground-based access poses safety risks. Environments where ground-based access poses safety risks include contaminated areas, structurally unstable zones, areas with active hazards, or locations with restricted human access. The drone-mounted configuration of the system allows inspection operations to be conducted from aerial positions without requiring personnel to enter hazardous environments. The remotely controlled mode of the system enables an operator to direct inspection operations from a safe distance while receiving real-time data from the GPR antenna and sensing elements.

A number of implementations have been described. Nevertheless, it will be understood that various modifications may be made without departing from the spirit and scope of the disclosure. Accordingly, other implementations are within the scope of the following claims.

1. A drone-mounted ground penetrating radar antenna positioning system, comprising:
a drone attachment platform configured to attach to a drone;
an upper platform disposed below the drone attachment platform, the upper platform housing a data processing and control circuit, a battery, and a voltage regulator circuit connected to the battery;
a lower platform disposed below the upper platform, the lower platform supporting a plurality of servo motors;
a plurality of pulleys mechanically coupled to the plurality of servo motors;
a plurality of ropes extending from the plurality of pulleys to a ground penetrating radar antenna suspended below the lower platform, wherein rotation of the plurality of servo motors causes movement of the plurality of ropes through the plurality of pulleys to adjust at least one of altitude and tilt of the ground penetrating radar antenna;
at least one infrared sensor disposed on the upper platform and oriented to face a downward direction; and
at least one depth camera disposed on the upper platform and oriented to face a downward direction, wherein the data processing and control circuit receives data from the at least one infrared sensor and the at least one depth camera and generates control signals for the plurality of servo motors to adjust the at least one of altitude and tilt of the ground penetrating radar antenna based on the received data.

2. The system of claim 1, wherein the plurality of servo motors provide constant position feedback to the data processing and control circuit, and wherein the data processing and control circuit uses the position feedback to determine a current altitude and tilt degree of the ground penetrating radar antenna.

3. The system of claim 2, wherein the data processing and control circuit generates control signals specifying rotation speed and rotation degree for each servo motor of the plurality of servo motors based on the position feedback and the data received from the at least one infrared sensor and the at least one depth camera.

4. The system of claim 1, further comprising a middle platform disposed between the upper platform and the lower platform, the middle platform connecting the upper platform to the lower platform.

5. The system of claim 4, further comprising a detachment mechanism disposed on the middle platform, the detachment mechanism comprising a detachment servo motor configured to release the system from the drone attachment platform when activated.

6. The system of claim 5, wherein the detachment servo motor comprises a servo motor head that resides within the drone attachment platform under normal operating conditions, and wherein the detachment servo motor is configured to rotate approximately 180 degrees to cause the servo motor head to reach an empty region of the drone attachment platform, thereby releasing the system from the drone attachment platform.

7. The system of claim 1, further comprising a GPS module disposed on the upper platform, the GPS module configured to broadcast location data of the system.

8. The system of claim 1, further comprising a wireless transmitter and receiver circuit disposed on the upper platform, the wireless transmitter and receiver circuit configured to transmit height variation data and a video stream to a remote operator and to receive adjustment commands from the remote operator.

9. The system of claim 1, wherein the at least one infrared sensor provides short-range height measurement data corresponding to distances between the system and an inspected surface, and wherein the at least one depth camera provides long-range obstacle detection data comprising depth images representing three-dimensional information about terrain below the system.

10. The system of claim 9, wherein the data processing and control circuit jointly analyzes the short-range height measurement data from the at least one infrared sensor and the long-range obstacle detection data from the at least one depth camera to determine altitude adjustments for the ground penetrating radar antenna.

11. The system of claim 1, wherein the data processing and control circuit is configured to operate in an automated mode in which the data processing and control circuit utilizes artificial intelligence-based analysis to adjust the altitude and tilt of the ground penetrating radar antenna in real-time based on the data received from the at least one infrared sensor and the at least one depth camera.

12. A method for adjusting a position of a ground penetrating radar antenna mounted to a drone, the method comprising:
receiving, by a data processing and control circuit, sensor data from at least one infrared sensor and at least one depth camera oriented to face a downward direction toward an inspected surface;
analyzing, by the data processing and control circuit, the sensor data to determine at least one of surface height variations and obstacles in a path of the ground penetrating radar antenna;
generating, by the data processing and control circuit, control signals for a plurality of servo motors based on the analyzed sensor data; and
rotating, by the plurality of servo motors, a plurality of pulleys to move a plurality of ropes connected to the ground penetrating radar antenna, thereby adjusting at least one of altitude and tilt of the ground penetrating radar antenna relative to the inspected surface.

13. The method of claim 12, wherein analyzing the sensor data comprises jointly analyzing short-range height measurement data from the at least one infrared sensor and long-range obstacle detection data from the at least one depth camera to determine the at least one of surface height variations and obstacles.

14. The method of claim 12, further comprising receiving, by the data processing and control circuit, position feedback from the plurality of servo motors, and wherein generating the control signals is further based on the position feedback.

15. The method of claim 12, wherein adjusting the tilt of the ground penetrating radar antenna comprises:
rotating servo motors on a first side of a lower platform while maintaining servo motors on a second side of the lower platform in a stationary position, thereby pulling ropes connected to the first side of the ground penetrating radar antenna while keeping ropes connected to the second side of the ground penetrating radar antenna at a current length to shift an orientation of the ground penetrating radar antenna from a horizontal orientation toward a vertical orientation.

16. The method of claim 15, further comprising:
determining, by the data processing and control circuit using computer vision-based distance estimation techniques, whether the shifted orientation of the ground penetrating radar antenna is sufficient for passing through a designated tight area; and
rotating all servo motors of the plurality of servo motors simultaneously to move the ground penetrating radar antenna through the designated tight area when the shifted orientation is determined to be sufficient.

17. A drone-mounted ground penetrating radar inspection system, comprising:
a peripheral system configured to attach to a drone, the peripheral system comprising:
a plurality of servo motors disposed on a lower platform;
a pulley and rope mechanism connected to the plurality of servo motors and extending to a ground penetrating radar antenna suspended below the peripheral system;
a data processing and control circuit configured to generate control signals for the plurality of servo motors;
at least one infrared sensor configured to detect surface height variations; and
at least one depth camera configured to detect obstacles; and
a detachment mechanism comprising a servo motor configured to release the peripheral system from the drone upon activation,
wherein the data processing and control circuit is configured to operate in at least one of an automated mode in which the data processing and control circuit automatically adjusts altitude and tilt of the ground penetrating radar antenna based on data from the at least one infrared sensor and the at least one depth camera, and a remotely-controlled mode in which the data processing and control circuit transmits data to a remote operator and receives adjustment commands from the remote operator.

18. The system of claim 17, further comprising a GPS module disposed on the peripheral system, the GPS module configured to broadcast location data of the peripheral system following activation of the detachment mechanism.

19. The system of claim 18, further comprising a wireless transmitter and receiver circuit disposed on the peripheral system, the wireless transmitter and receiver circuit configured to transmit the location data from the GPS module and to transmit height variation data and a video stream to the remote operator in the remotely controlled mode.

20. The system of claim 17, wherein the data processing and control circuit is configured to utilize artificial intelligence-based processing algorithms including computer vision-based distance estimation techniques to determine whether an orientation of the ground penetrating radar antenna is sufficient for passing through a designated tight area, and wherein the data processing and control circuit is configured to generate control signals to rotate servo motors on a first side of the lower platform while maintaining servo motors on a second side of the lower platform in a stationary position to shift the orientation of the ground penetrating radar antenna from a horizontal orientation toward a vertical orientation.
